(19) United States
(12) Patent Application Publication
(10) Pub. No.: US 2005/0019100 A1
(43) Pub. Date: Jan. 27, 2005

(54) Apparatus for laying a conduit on the seabed from a floating vessel

(76) Inventor: Nigel Simpson, Inverbervie (GB)

Correspondence Address: HAYNES AND BOONE, LLP, 901 MAIN STREET, SUITE 3100, DALLAS, TX, 75202, US

(21) Appl. No.: 10/487,332

(22) PCT Filed: Aug. 21, 2002
(86) PCT No.: PCT/EP02/09347

(30) Foreign Application Priority Data
Aug. 22, 2001 (GB) 0120432.0

(51) Int. Cl. F16L 1/00; B63B 35/03

(52) U.S. Cl. 405/166; 405/154.1; 405/158

(57) ABSTRACT

Pipe (3) to be laid on the seabed from a floating pipe laying vessel (1) emerges from the bottom end of a vertically orientated linear pipe tensioner (8b) and is directed substantially vertically downwardly to pass through a surrounding pipe guide (12), which causes the pipe to deviate from the vertical through a small acute angle (θ). In this way, the horizontal thrust that would be exerted on the pipe tensioner (8b) due to the tension in the pipe if the tensioner were to be the last guide means for the pipe before it enters the sea is transferred to the pipe guide itself, this being mounted in the vessel at a location of greater structural strength.

This invention relates to apparatus for laying a conduit on the seabed from a floating vessel. More particularly, though not exclusively, the invention is concerned with laying a flexible or rigid pipe for conveying a hydrocarbon-containing fluid, for example a production fluid from a subsea well. Alternatively, the pipe may be used for water, such as may be needed for water injection, or it may indeed be used for conveying any fluid, gaseous or liquid.

When a flexible or rigid pipe is laid from a floating vessel on the seabed, the pipe suspended in the water assumes the shape of a catenary. With developments in technology, pipes have been laid at ever increasing depths. As the depth increases, so the angle at which the pipe enters the sea from the floating vessel increases, such that when laying at depths of, say, 100 metres or more, depending on pipe diameter, it becomes nearly vertical as the pipe enters the sea. EP-A-0 478 742 to Coflexip relates to apparatus on a floating vessel designed to lay flexible pipe or other flexible conduit, such as a cable, at large depths, in which a linear pipe (or cable) tensioner on the vessel with a substantially vertical axis is used to grip the outer surface of a flexible conduit so as to take up substantially the entire downward pull of the pipe in the water. The apparatus also includes an auxiliary tensioner or winch to which the pull of the pipe is transferred when passing an accessory on the pipe through the main linear tensioning means. The tension in the section of pipe between the linear pipe tensioner and the storage drum from which the pipe is drawn is, in relative terms very small, so that the pipe section can pass over a guide to the tensioner without the pipe being crushed and without damage caused by passing an accessory over the guide.

One critical feature of the apparatus disclosed in EP-A-0 478 742 resides in the absence of any means for guiding the flexible pipe after it has left the main linear tensioning means. In other words, the main tensioning means constitutes the last means for guiding the pipe on the floating vessel.

Owing to the pipe orientation as it passes clear beneath the main linear tensioning means, the pipe applies a horizontal force component on the main tensioner. Indeed, EP-A-0 478 742 refers to the main tensioning means ensuring guidance for the flexible pipe and a deviation relative to the vertical. It specifically mentions that a multi-caterpillar tensioning means can generally permit a deviation of more or less 10 to 15 degrees relative to the vertical.

Although the horizontal force component exerted on the tensioner is very much less than the tension in the pipe, nevertheless as an absolute amount it can be sizeable. For example, if the tension in the pipe is, say, 120 tons, then when the pipe is at a deviation of 10 degrees to the vertical, say, the horizontal force applied to the pipe is approximately 20.8 tons.

The main tensioning means is supported on a derrick projecting upwardly from the pipelaying vessel. Therefore, this derrick needs to be designed to be strong enough to withstand the horizontal forces (say 20 tons or more) acting on the main tensioning means. Furthermore, the main tensioning means itself also has to withstand such horizontal forces. However, the latter has the principal task of acting vertically upwardly to counter-balance the pull of the pipe. The need to also be able to withstand horizontal forces, particularly having regard to the fact that the main tensioner has a number of moving parts, such as caterpillar tracks, drive and idling wheels, imposes special requirements on the design of the linear tensioning means.

Still further, the main tensioning means has to be adjustable to accommodate pipes of different diameters, such as by arranging for the facing caterpillar tracks to be adjustable in position relative to one another in a horizontal direction, such as to accommodate pipes of different diameter and to pass accessories. Again, the need for such adjustability imposes special demands on the design of the main linear tensioning means, in order that it can adequately withstand the horizontal loading imposed on it.

There exists a commercial vessel, Sunrise 2000, operated by Stena Coflexip Offshore, in which pipe is laid over the stern of the vessel using a vertical tensioner above a work platform and a pair of spaced-apart restrainers on the work platform, which each extend fore-aft and between which the pipe passes. As pipe laying proceeds, the pipe adjusts its position between the restrainers in which the forces acting are in equilibrium. Under these conditions, there will be horizontal loading on the main vertical tensioner.

Accordingly, the need exists for an improved design for the conduit-laying apparatus, which avoids the need to design the linear tensioning means, as well as the derrick on which it is supported, to withstand horizontal loading.

Reference is made to U.S. Pat. No. 4,472,079 which discloses a conventional deepwater drilling ship having a derrick on the ship, a moonpool in the ship's hull and a stinger located below the moonpool and attached to the underside of the ship's hull. Lengths of pipe are put together to form a pipeline in the derrick, passed through the moonpool and guided by the stinger into the required catenary shape in which the pipeline is suspended from the vessel to the seabed. No details are given in U.S. Pat. No. 4,472,079 on how the pipeline is supported in the derrick.

WO-A-9635902 discloses marine pipe laying equipment on a drilling vessel. Pipe to be laid is fed from a storage reel over a bending shoe, mounted on a derrick structure located above a moonpool in the hull of the vessel, through a straightening assembly suspended from the derrick structure and into the water via the moonpool. The pipeline is straightened by being fed piece-wise from the reel and being clamped, while the straightener assembly is drawn upwards along a length of the pipe extending between the bending shoe and the moonpool. A stinger assembly may be fitted to the bottom of the vessel so as to divert the pipeline to the required angle as it exits the bottom of the moonpool.

According to the invention from one aspect, there is provided apparatus for laying a conduit on the seabed from a floating vessel incorporating a moonpool, comprising: (i) linear tensioning means located on the vessel above the moonpool, with a substantially vertical axis for gripping the exterior of the conduit passing downwardly through the moonpool for counteracting its downward pull, and (ii) a guide on the vessel disposed in the moonpool below the linear tensioning means for reorientating the conduit from a first, substantially vertically downward, orientation between the tensioning means and the guide to a second, inclined, orientation at an acute angle θ to said first orientation, as the conduit leaves the guide, the guide surrounding the conduit.

It will be appreciated that the reorientation of the conduit from substantially vertically downwards to the required deviation from the vertical is afforded by the guide in the moonpool, rather than by the linear tensioning means. Therefore, the necessary horizontal forces acting on the conduit are provided by the guide. It will be noted that since the guide surrounds the conduit, the guide will itself withstand the horizontal loading due to the tension in the conduit irrespective of the direction in which the pipe is being laid (as seen from above) relative to the vessel. Furthermore, since the guide does not need to have any moving parts and can itself be supported on the vessel hull structure, preferably via a moonpool door or work platform in the moonpool or at the stern of the vessel respectively, it is much easier to design an appropriate rigid support for firmly holding the guide.

In one preferred arrangement, the bottom edge of the moonpool is rounded off. As a result, any risk of damage to the conduit and moonpool caused by contact between the conduit and the bottom circumferential edge of the moonpool, for example when laying conduit in rough sea conditions causing the vessel to heave, pitch and roll and/or when the tension in the conduit is sufficiently large to bring about contact between the conduit and the bottom edge of the moonpool, is minimized.

According to the invention from another aspect, there is provided apparatus for laying a conduit on the seabed from a floating vessel, comprising: (i) linear tensioning means located on the vessel with a substantially vertical axis for gripping the exterior of the conduit for counteracting its downward pull, and (ii) a guide on the vessel disposed below the linear tensioning means and having a fixed guide surface for reorientating the conduit from a first, substantially vertically downward, orientation between the tensioning means and the guide to a second, inclined, orientation at an acute angle (θ) to said first orientation, as the conduit leaves the guide, the guide surrounding the conduit.

The use of a guide having a fixed guide surface for reorientating the conduit contrasts with the stinger disclosed in the aforesaid U.S. Pat No. 4,472,079, which has articulated joints which impart flexibility to the stinger. Furthermore, in the case of the aforesaid WO-A-9635902, there is no teaching that the optimal stinger surrounds the conduit.

Preferably, the vessel incorporates a moonpool, the tensioning means being located above the moonpool for gripping the exterior of a conduit passing downwardly through the moonpool and the guide being disposed in the moonpool, the bottom edge of the moonpool being rounded off.

Suitably in the apparatus according to the first or second aspect, the guide is mounted on a cover on the moonpool and depends downwardly therefrom. Access to the guide for inspection and servicing can then easily be obtained by opening or removing the cover.

In a preferred arrangement, the pipe guide and moonpool cover are axially divided and each half cover with its half pipe guide is slideable in a lateral direction under the action of a respective hydraulic cylinder, to retract the half covers to respective port and starboard positions. The space thereby provided between the open moonpool door halves allows accessories on the pipe to be passed through the moonpool, such as during pipelaying or in an abandon and recovery operation.

Alternatively, the tensioning means and guide may be located at the stern of the vessel, the guide being axially divided and each half guide being slideable in a lateral direction under the action of a respective hydraulic cylinder.

In either case, it is preferred that the pipe guide comprises two flared sidewalls which form a Vee in horizontal cross-section, the apex of the Vee being located aft in the moonpool. With such an arrangement, when the vessel is laying conduit when travelling in the fore direction or within a range of acute angles to port or to starboard relative to the fore direction, the conduit will remain in contact with, and be guided by, the two sidewalls. Furthermore, different conduit diameters can be accommodated by such guide.

In a preferred arrangement, the guide is arranged to surround the conduit. It will then generally take the form of an inverted funnel. Such arrangement is advantageous in that in whichever direction the vessel is to be propelled relative to the fore-aft direction, for example if it is travelling aft, or even to port or to starboard (pipelaying vessels are often equipped with lateral thrusters), then the conduit will always be guided through the moonpool by the guide.

It is particularly preferred that the guide comprises two further flared sidewalls, the four sidewalls being so arranged as to define a central passageway within the guide that is square in horizontal section. A guide of such design is relatively straightforward to manufacture. Furthermore, the conduit will automatically bring itself into contact with one adjacent pair of sidewalls or another, according to the direction in which the conduit is being laid relative to the floating vessel.

In order to accommodate conduits of different diameter, the central axis of the guide may be offset in the fore or aft direction relative to the substantially vertical axis of the linear tensioning means. Then, the smallest conduit that could be used with the conduit laying apparatus would be one which would hang vertically downwardly from the main linear tensioning means and just touch the two aft (or fore, as the case may be) side walls of the guide and whose radial dimension would correspond to the spacing between each of the two side walls and the downwardly projected substantially vertical axis of the linear tensioning means. The largest diameter conduit which could be passed through the guide would be the one whose radial dimension corresponds to the spacing between the central axis of the guide and its sidewalls. In the latter case, it will be appreciated that the conduit will be caused to deviate slightly from the vertical in the fore (or aft) direction as it passes downwardly from the linear tensioning means to the guide entry, but the angle of deviation in this case is typically very small, and significantly less than the angle of deviation of the conduit, and the resulting horizontal force acting on the main tensioning means under these circumstances is much less than with the arrangement disclosed in the aforesaid EP-A-0 478 742 or used in Sunrise 2000, in which there is no guide below the tensioning means.

A hang-off device may be located between the moonpool and the tensioner and in substantially vertical alignment with the guide. This hang-off device is used for temporarily supporting an end fitting on the conduit, before lowering it through the moonpool, as will be described in more detail hereinbelow.

According to a method of laying a pipe on the seabed using an apparatus as defined initially, the exterior of the conduit is gripped by the tensioning means which lowers the conduit, the tensioning means counteracting its downward pull and the guide reorientating the conduit from the first orientation to the second orientation at said acute angle to the first one.

For a better understanding of the invention and to show how the same may be carried into effect, reference will now be made, by way of example, to the accompanying drawings, in which:

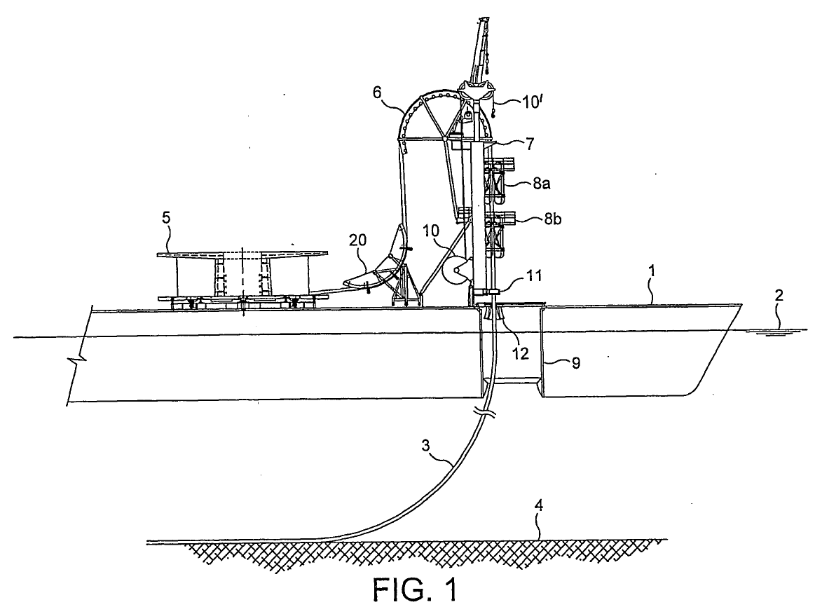

FIG. 1 is a diagrammatic side elevation of a vessel equipped with one form of pipelaying apparatus in accordance with the invention,

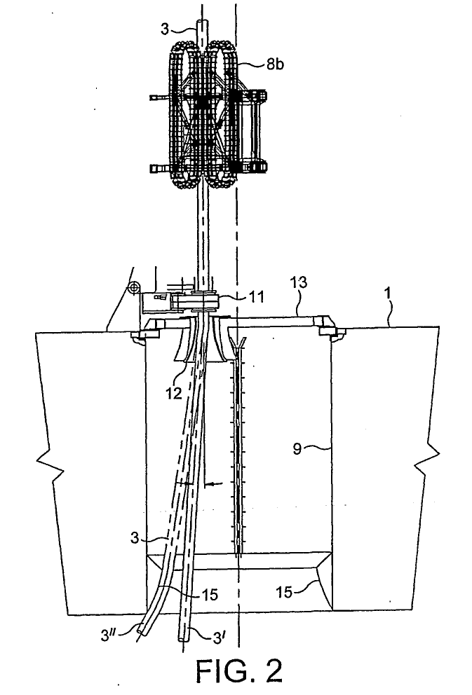

FIG. 2 is a side elevational view on an enlarged scale, partly cut away, showing parts of the conduit-laying apparatus in more detail,

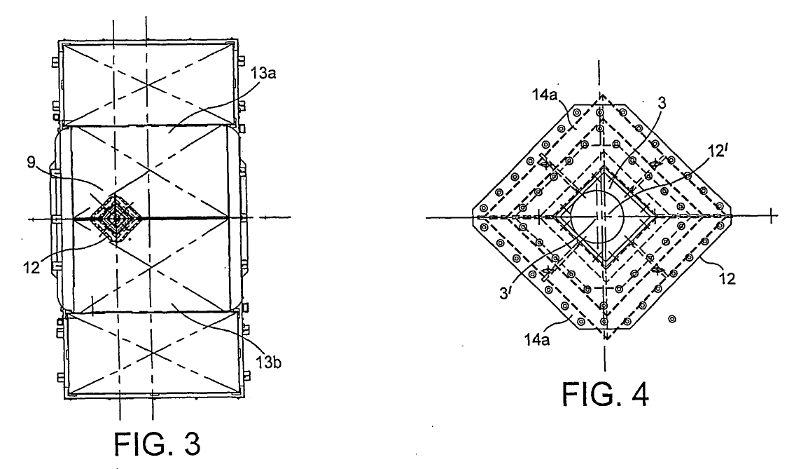

FIG. 3 is a plan view of the moonpool of the pipe laying vessel,

FIG. 4 is a plan view on an enlarged scale of the guide showing the position of the pipe being laid as it passes through the open upper end of a pipe guide, and

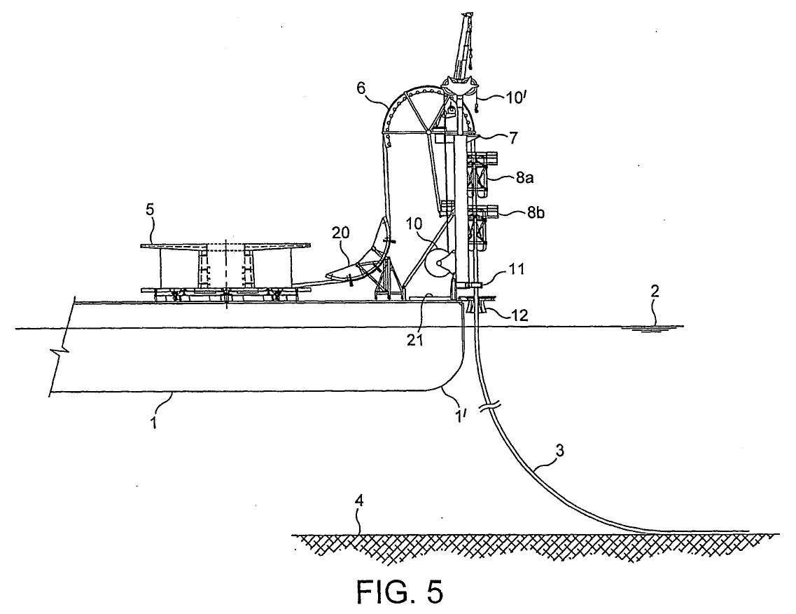

FIG. 5 is a diagrammatic side elevation of a second embodiment of the invention.

Referring to FIG. 1, there is shown a diagrammatic side elevational view of a pipelaying vessel 1 floating on a body of water 2, laying a flexible pipe 3 on the seabed 4. The vessel 1 is provided with a pipe storage drum 5 or the like, on which is stored a length of wound flexible pipe 3 which is being laid aft of the vessel as the latter is propelled generally in the fore direction. The axis of rotation of the drum may be vertically arranged as shown, or the drum may be mounted for rotation about a horizontal axis. The pipe leaving the drum initially passes beneath a first deflector or guide 20 which re-directs the pipe upwardly and over a second deflector or guide 6, supported on a derrick or tower structure 7 on the vessel, and then passes substantially vertically downwardly through a pair of upper and lower, spaced apart, linear caterpillar tensioners 8a, 8b, also mounted on the derrick, and then a moonpool 9 in the vessel hull located beneath the derrick, before leaving the vessel hull and being suspended in the body of water down to the seabed, in the shape of a catenary. Using a pair of tensioners distributes the loading between the two tensioners, but a single tensioner may be used instead if it has sufficient load carrying capacity for the pipe being laid.

The linear pipe tensioners 8a, 8b together perform the function of counteracting substantially the whole of the downward pull exerted by the pipe, which is due to the tension acting in it, which in turn is due to factors such as the weight of the pipe, the hydrodynamic forces acting on it and the shape of the catenary in which the pipe is suspended. Each tensioner does this by gripping the pipe over a portion of the exterior of the pipe which it keeps straight, so that there is no bending of the pipe over its axial extent which is gripped externally by the pipe tensioner 8. Furthermore, each pipe tensioner is arranged with its axis, coinciding with the linear portion of the pipe which is gripped, in a substantially vertical orientation. Since the tensioners together counteract (substantially the whole of) the downward pull of the pipe, the section of pipe ahead of the tensioner, from the drum 5 and under the first deflector or guide 20 and up and over the second deflector or guide 6 and down to the entry point on the top of the upper linear tensioner 8a is under minimal tension. In this way, any accessories, not shown, on the pipe, such as end connectors, may be passed under the deflector or guide 20 and over the deflector or guide 6 without damage to either guide or the pipe itself. Furthermore, accessories may be passed through the tensioner pair 8a, 8b from above in known manner, such as by connecting each accessory to the overhead line 10′ of an auxiliary winch 10 on the derrick 7 and then transferring the pull of the pipe to that winch, so that the tensioners can be opened laterally and the auxiliary winch then lowers the accessory through the open tensioners. A hang-off clamp 11 on the derrick located below the bottom tensioner 8b may be used for engaging the accessory on the pipe and for temporarily supporting the pipe suspended in the water, so that the line of the auxiliary winch 10 may be disconnected from the accessory and raised through the open tensioners back to its original position.

The particular form that each linear pipe tensioner takes is not critical. A particularly convenient form of tensioner, shown in FIG. 2, is one comprising a pair of opposed caterpillar tracks which are separated by a small gap through which the pipe passes with the caterpillar tracks engaged with the pipe exterior on opposite sides. The tensioner may alternatively comprise four caterpillar tracks arranged at 90° angular spacings about the pipe axis so as to grip the pipe exterior along four linear sections angularly spaced at 90° intervals about the pipe, or alternatively a corresponding arrangement comprising three caterpillar tracks spaced at 120° intervals may be used. Other possible forms for the tensioner include one having pipe gripping tyres, a step-wise gripper or a hybrid form of tensioner, examples of which are known in the art. The particular form of tensioner that is used is a matter of choice according to the particular design requirements involved.

By way of example, the disclosed pipe laying apparatus is intended for laying pipe at relatively large depths, which might typically be 250 metres or more though it could be used in shallower waters, at depths from 40 m and upwards. When laying pipes at these depths with the main tensioners having a substantially vertical axis, the pipe is laid in the so-called J-lay configuration.

The pipe laying apparatus as described so far is similar to that disclosed in the above-mentioned EP-A-0 478 742. In that Application, the pair of linear pipe tensioners is the last means for guiding the pipe at the level of the floating vessel. However, even when laying at great sea depths, the pipe does not normally hang precisely vertically downwardly where it emerges from the lower end of the tensioner. This is because the tension in the pipe causes it to deviate by a small acute angle from the vertical as it emerges from the exit point of the main tensioner. Furthermore, the pipe has to maintain a minimum bend radius on the seabed touchdown to avoid buckling. This bend radius is effectively maintained by the pipe being “dragged” slightly by the vessel. In other words, the tensioner exit point is always horizontally offset, relative to the seabed touchdown point. This offset is normally in the direction of laying. As specifically mentioned in EP-A-0 478 742, the function of the pair of linear pipe tensioners is to ensure both guidance for the flexible pipe and a deviation relative to the vertical, which would be a few degrees typically, but which could for example be as much as more or less 10° to 150° relative to the vertical. Although such angle is relatively small, it will be appreciated that since the tension in the pipe can be very large, typically of the order of 50 to 100 tons or so, or even a few hundred tons, the deviation of the pipe from the vertical where it emerges from the lower end of the pipe tensioner will cause a horizontal force component to be applied to the tensioner, which the tensioner has to be designed to withstand. For example, for a tension in the pipe of 120 tons, the horizontal force that the tensioner has to withstand would be 120×cosine 80°=20.8 tons. This presents problems for the design of the pipe tensioner, particularly since it contains a number of moving parts and features an adjustable gap between the drive elements of each tensioner so that adjustment can be made to accommodate pipes of different external diameters and to allow the tensioners to be fully opened to allow accessories to pass through. It would be highly desirable to design the apparatus such that little or substantially no horizontal force is exerted on each pipe tensioner, due to the tension acting in the pipe deviating from the vertical as it emerges from the bottom of the lower tensioner 8b. The manner in which this objective is achieved is best shown in FIGS. 2 and 3, to which reference is now made.

Referring to FIG. 2, a pipe guide 12 is located in the moonpool 9 directly below the tensioners 8a, 8b. This guide is generally in the shape of an inverted funnel, defining a central passageway flaring outwardly from its upper entry end to its lower exit end, through which the pipe passes. Preferably, as shown in FIG. 3, the guide is of fore-aft split construction, with each port and starboard guide half mounted on a respective moonpool door 13a, 13b. These doors are laterally slideable, to port and starboard respectively, under the action of hydraulic cylinders, diagrammatically shown at 15a, 15b. The doors when closed cover the open top of the moonpool 9, and the guide depends downwardly from the underside of the moonpool doors.

The moonpool 9 itself is generally square in horizontal cross-section and its cover doors 13a, 13b are of corresponding shape, as indicated in FIG. 3. As best shown in the enlarged plan view of FIG. 4, the pipe guide comprises four flared side walls defining the flared central passageway, which is also of square cross-section, increasing in size towards the lower end of the guide. It will also be noted that the horizontal square cross-section of the guide passageway, considered at any depth from the upper end of the guide, is angularly offset by 45° about the vertical axis of the guide relative to the corresponding square cross-section of the moonpool, such that the two aft, outwardly flared side walls 14a form a Vee in horizontal cross-section where they meet. Therefore, if the vessel is moving in the fore direction or within an angle of up to about 45° to port or to starboard of the fore direction while the vessel is laying pipe, then the pipe itself will be held in contact with the two aft side walls 14a as the pipe is being laid, while the outward flaring of the downwardly depending side walls 14a will allow the pipe to be deflected through a small acute angle θ to the vertical axis of the tensioners, which angle θ as mentioned above may be up to about 10 to 15°.

It is important to note that since the pipe 3 is substantially vertical between the lower end of the lower linear pipe tensioner 8b and the upper end of the pipe guide 12, substantially no horizontal force will act on the main tensioner 8, irrespective of the magnitude of the tension in the pipe. Rather, this horizontal loading will be applied to the pipe guide 12. However, this guide can readily be designed to withstand such loading, partly because the pipe guide itself does not have any moving parts and partly since its two halves are firmly mounted on the moonpool doors, which in turn are firmly held in position by the hydraulic cylinders 15a, 15b, these in turn being rigidly mounted on the deck structure of the vessel, which is a structurally strong part of the vessel's overall structure.

Important advantages result from the disclosed design for the pipe guide, as may now be appreciated from FIG. 4 in particular. In this Figure, the indicated pipe diameter is the smallest pipe size that is intended to be used with the pipe laying apparatus. It will be seen that the substantially vertical central axis 12′ of the pipe guide is offset in the fore direction by a small amount relative to the centre line 3′ of the pipe 3, which is coincident with the substantially vertical axis of the main tensioner 8 (since both it and the pipe between the tensioner and the guide are substantially vertical). This means that the same pipe guide can be used with pipes of larger diameter, up to the pipe diameter for which the centre line of the pipe, while the pipe is held in contact with the aft side walls 14a, coincides with the substantially vertical central axis of the pipe guide 12. It will be appreciated that in accordance with a modification, the offset of the guide relative to the tensioner can be in the aft, rather than the fore, direction.

It is also to be noted that although the vessel would normally lay pipe while travelling in the fore direction or within an angle to port or starboard or about a maximum of 45° (so as to maintain pipe contact with the aft side walls 14a), the fact that the pipe guide surrounds the pipe and its cross-sectional shape provides three further pairs of flared side walls meeting in respective Vees means that the pipe will always be guided by an adjacent pair of side walls, whether the vessel is travelling to port, or to starboard, or to aft, or in any other direction between these principal directions. It is remarked in this connection that it is known for pipe laying vessels to be provided with side thrusters in addition to a main propulsion drive that will apply tractive force to the vessel selectably in the fore/aft and port/starboard direction.

The axially split design for the pipe guide and moonpool doors enables an end flange or other accessory on the pipe to be passed through the space between the open doors when they have been slideably withdrawn to their port and starboard positions respectively, such as when it is required to lay a further length of pipe which is connected by its end flange to that on the top of pipe 3 or when the pipe 3 is to be abandoned on the seabed for later recovery in known fashion by attaching a line of an A-R winch (not shown) on the vessel to the pipe end flange.

Preferably, the inner surfaces of the side walls of the pipe guide are made of a suitable anti-friction material, of a suitable kind such as is well-known in the art. Furthermore, it is preferred that the bottom edge of the moonpool 15 is rounded off, as indicated in FIG. 2. Although the internal dimensions of the moonpool are chosen such that under normal pipe laying conditions the pipe 3 will not deviate by a sufficient angle θ from the vertical such that it comes into contact with any portion of the bottom edge 15 of the moonpool (as indicated by reference numeral 3′ for the pipe shown in continuous outline), it can happen occasionally that the vessel pitches, heaves and rolls under adverse sea conditions such that the pipe may from time to time come into contact with the bottom edge of the moonpool, causing the pipe to deflect further from the vertical at that location as indicated by reference numeral 3″ for the pipe shown in broken outline. The rounding of the bottom edge of the moonpool minimizes the risk of damage to the pipe or the bottom edge of the moonpool.

Another embodiment is shown in FIG. 5, in which the pipelaying apparatus on the vessel is provided at the stern 1′ of the vessel rather than in the region of the moonpool as in the first embodiment. Like reference numerals used in FIG. 5 denote the same or corresponding elements in FIGS. 1 to 4. In the present embodiment 12, a horizontal structure 21 is secured to the deck structure and cantilevered out over the stern 1′ of the vessel to support the guide 12, which depends downwardly from the horizontal structure.

It is alternatively possible to provide the pipe laying apparatus at the bow of the vessel. Whether mounted at the vessel bow or stern, the guide could be mounted on the derrick itself rather than on a horizontal structure cantilevered from the end of the deck structure.

It will be readily appreciated that various modifications to the described pipe laying apparatus are possible within the scope of the appended claims. For example, other possible shapes for the inverted funnel-shaped pipe guide are possible, such as one having a circular internal cross-section at all heights within the guide. It is also not critical that the moonpool be square in horizontal cross-sectional shape, nor that the pipe guide 12 be arranged centrally within the moonpool. In the first embodiment described, it is offset in the aft direction.

In view of the foregoing description, it will be appreciated that the disclosed pipe guide provides a simple, cheap and effective way of re-orientating the pipe, which avoids imposing any non-negligible horizontal loading on the main tensioners.

In the specification, the invention has been exemplified with reference to the laying of a flexible pipe. However, it is to be understood that the invention also finds application to the laying of other forms of flexible conduit, such as a cable. Furthermore, the apparatus is not restricted to the laying of flexible pipes and cables, but it may also be used for laying conduits that are rigid, in particular (though not exclusively) rigid pipes, providing the deviation from the vertical at the point where the pipe leaves the pipe guide in the moonpool can be accommodated within the elastic deformation of the pipe. The described pipe laying apparatus may be used for the laying of rigid pipes by making the known minor modification of including a pipe straightener, such as a straightening device, through or past which the rigid pipe is drawn from the drum on which it is wound and stored in a state of plastic deformation, so as to remove such plastic deformation before the pipe reaches through the main tensioners. An example of a pipe laying apparatus that could be used for performing such straightening of the pipe before it is drawn through the pipe tensioners and then passed downwardly through the moonpool via the pipe guide, is disclosed in U.S. Pat. No. 3,982,402 to Lang et al.

Finally, it is remarked that the terminology “substantially vertical” and corresponding terms used in this specification indicate a vertical orientation or almost vertical orientation, with respect to the horizontal fore-aft axis of the vessel. Of course, if the vessel were to be pitching, heaving or rolling significantly, then the substantially vertical direction would continuously deviate significantly from the true vertical direction, but its orientation relative to the fore-aft axis would remain fixed. Therefore, the term “substantially vertical” and the like as used in this specification is defined relative to the fore-aft direction of the ship and not with respect to the true vertical direction.

1. Apparatus for laying a conduit on the seabed from a floating vessel incorporating a moonpool, comprising:
(i) linear tensioning means (8) located on the vessel (1) above the moonpool (9), with a substantially vertical axis for gripping the exterior of the conduit (3) passing downwardly through the moonpool for counteracting its downward pull, and
(ii) a guide (12) on the vessel disposed in the moonpool below the linear tensioning means (8) for reorientating the conduit from a first, substantially vertically downward, orientation between the tensioning means and the guide to a second, inclined, orientation at an acute angle (θ) to said first orientation, as the conduit leaves the guide (12), the guide surrounding the conduit (3).

2. Apparatus according to claim 1, wherein the bottom edge (15) of the moonpool is rounded off.

3. Apparatus according to claim 2, wherein the guide (12) is mounted on a cover (13) on the moonpool (9) and depends downwardly therefrom.

4. Apparatus according to claim 3, wherein the guide (12) and moonpool cover (13) are axially divided and each half cover with its half guide is slideable in a lateral direction under the action of a respective hydraulic cylinder (15a:15b).

5. Apparatus according to claim 1, wherein the tensioning means (8) and guide (12) are located at the stern of the vessel, the guide being axially divided and each half guide is slideable in a lateral direction under the action of a respective hydraulic cylinder.

6. Apparatus according to any preceding claim, wherein the pipe guide comprises two flared sidewalls (14a) which form a Vee in horizontal cross-section, the apex of the Vee being located in an aft position in the vessel.

7. Apparatus according to claim 6, wherein the guide (12) comprises two further flared sidewalls, the four sidewalls being so arranged as to define a central passageway within the guide that is square in horizontal section.

8. Apparatus according to claim 7, wherein the central axis (12′) of the guide (12) is offset in the fore or aft direction relative to the substantially vertical axis of the linear tensioning means.

9. A method of laying a conduit on the seabed using an apparatus according to any preceding claim, wherein the exterior of the conduit (3) is gripped by the tensioning means (8) which lowers the conduit, the tensioning means counteracting its downward pull and the guide (12) reorientating the conduit from the first orientation to the second orientation at said acute angle to the first one.

10. Apparatus for laying a conduit on the seabed from a floating vessel, comprising:
(i) linear tensioning means (8) located on the vessel (1) with a substantially vertical axis for gripping the exterior of the conduit (3) for counteracting its downward pull, and
(ii) a guide (12) on the vessel disposed below the linear tensioning means (8) and having a fixed guide surface for reorientating the conduit from a first, substantially vertically downward, orientation between the tensioning means and the guide to a second, inclined, orientation at an acute angle (θ) to said first orientation, as the conduit leaves the guide (12), the guide surrounding the conduit (3).

11. Apparatus according to claim 10, wherein the vessel incorporates a moonpool (9), the tensioning means (8) being located above the moonpool for gripping the exterior of a conduit (3) passing downwardly through the moonpool and the guide (12) being disposed in the moonpool, the bottom edge (15) of the moonpool being rounded off.

12. Apparatus according to claim 11, wherein the guide (12) is mounted on a cover (13) on the moonpool (9) and depends downwardly therefrom.

13. Apparatus according to claim 12, wherein the guide (12) and moonpool cover (13) are axially divided and each half cover with its half guide is slideable in a lateral direction under the action of a respective hydraulic cylinder (15a:15b).

14. Apparatus according to claim 10, wherein the tensioning means (8) and guide (12) are located at the stern of the vessel, the guide being axially divided and each half guide is slideable in a lateral direction under the action of a respective hydraulic cylinder.

15. Apparatus according to any one of claims 10 to 14, wherein the guide comprises two flared sidewalls (14a) which form a Vee in horizontal cross-section, the apex of the Vee being located in an aft position in the vessel.

16. Apparatus according to claim 15, wherein the guide (12) comprises two further flared sidewalls, the four sidewalls being so arranged as to define a central passageway within the guide that is square in horizontal section.

17. Apparatus according to claim. 16, wherein the central axis (12′) of the guide (12) is offset in the fore or aft direction relative to the substantially vertical axis of the linear tensioning means.

18. A method of laying a conduit on the seabed using an apparatus according to any one of claims 10 to 18, wherein the exterior of the conduit (3) is gripped by the tensioning means (8) which lowers the conduit, the tensioning means counteracting its downward pull and the fixed guide surface reorientating the conduit from the first orientation to the second orientation at said acute angle to the first one.

19. A method according to claim 9 or 18, wherein the conduit is a flexible pipe.

20. Apparatus according to any one of claims 1 to 8 and 10 to 17, wherein a tower structure (7) is located on the vessel (1), the linear tensioning means (8) is mounted on the tower structure, and the guide (12) is mounted on the vessel (1) separately from the tower structure (7).
